(19) United States
(12) Patent Application Publication
(10) Pub. No.: US 2017/0372282 A1
(43) Pub. Date: Dec. 28, 2017

(54) DIGITAL IMAGE TAGGING FOR SPLIT TRANSACTION PROCESSING

(71) Applicant: PAYPAL, INC., San Jose, CA (US)

(72) Inventor: Pankaj Sarin, New Delhi (IN)

(21) Appl. No.: 15/194,191

(22) Filed: Jun. 27, 2016

(51) Int. Cl. G06Q 20/10; G06Q 50/00

(52) U.S. Cl. CPC G06Q 20/102; G06Q 50/01

(57) ABSTRACT

There are provided systems and methods for digital image tagging for split transaction processing. A user may utilize a communication device to capture one or more images of the user and other users located with the user, which may be posted to an image sharing platform, such as a social network. The user may also provide posts identifying the other users with the user. Utilizing the posted data, a service provider may determine that other users are with the user at the time and/or location of the posted data. The service provider may determine a transaction that the user processed, and may determine other users splitting or involved in the transaction based on the posted data. Thus, the service provider may request that the other users provide the required reimbursement to the user that processed the transaction based on the posted data.

### TECHNICAL FIELD

The present application generally relates to digital images and user identifiers, and more specifically to digital image tagging for split transaction processing.

### BACKGROUND

Users may perform transactions together with other users, for example, when out dining with other users, all of the users may purchase items that are gathered into one transaction or bill for the group of users. In this regard, a user may visit a physical merchant location with other users, where each of the users selects one or more items for purchase, where the merchant provides all of the users with a single transaction or bill for all of the users. Often, the users are required to engage in check splitting, which may be laborious and/or difficult based on the items each user purchased. Additionally, check splitting may cause a merchant to run multiple different payment instruments, which similarly may be time consuming and difficult for the merchant. Thus, multiple payment instruments provided to process a single transaction may be undesirable for all parties involved in the transaction.

Users may utilize communication devices to perform various actions, including transaction processing at physical merchant locations, as well as social networking, media sharing, microblogging, and other actions associated with online services. Thus, a user may post a social networking comment or image that includes one or more other users with the user. For example, the user may “tag” other users on a social networking platform, where the tag includes an identifier for the other users. Thus, the service provider and other service provider may determine identities and/or information for other users with the user providing a post to the social networking platform, as well as the time and/or location that the other users were located with the user.

### BRIEF DESCRIPTION OF THE DRAWINGS

FIG. 1 is a block diagram of a networked system suitable for implementing the processes described herein, according to an embodiment;

FIG. 2A is an exemplary graphical user interface of an application capturing an image of multiple users involved in a split transaction, according to an embodiment;

FIG. 2B is an exemplary graphical user interface of an application processing a split transaction between a group of users, according to an embodiment;

FIG. 2C is an exemplary graphical user interface of an application displaying reimbursement transactions to a user that processed a split transaction from the other users in a split transaction, according to an embodiment;

FIG. 3 is an exemplary system environment showing a communication device interacting with a service provider for digital image tagging for split transaction processing, according to an embodiment;

FIG. 4 is a flowchart of an exemplary process for digital image tagging for split transaction processing, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for digital image tagging for split transaction processing. Systems suitable for practicing methods of the present disclosure are also provided.

Users may utilize online platforms, resources, and/or services to share information with other users. For example, a social networking platform (e.g., FACEBOOK®) may provide a user with an account where the user may share media and post text and/or digital content (e.g., images, videos, emojis or other visual icons, etc.). In other embodiments, the users may utilize different types of online services to share information, including media sharing services (e.g., for sharing of images and/or videos, such as YOUTUBE®, INSTAGRAM®, or IMGUR®), a microblogging service (e.g., for sharing of small text blog posts and/or images/videos, such as TWITTER®), or other online service. The users may therefore post data to the online services, where the posted data may correspond to text, image, video, and/or other data (e.g., visual icons, such as emojis, animated images, etc.). The posted data may include information that the user wishes to convey to other users and/or wishes to store to the online service. For example, the posted data may inform other users of where the user is and/or what the user is currently doing. Additionally, the posted data may include a timestamp, location of the posted data, and/or other metadata associated with the user and/or user's account, generation of the posted data, and/or posting of the posted data to the online service.

Moreover, users may utilize various types of devices to capture images, including digital cameras, mobile smart phones, tablet computers, digital video recorders, gaming systems including mobile gaming systems, and other types electronic devices capable of capturing an image or video of the user. Thus, although the terms “image,” “video,” or the like may be used throughout, it is understood that other forms of image data may also be captured. In this regard, an image or video may also include a representation or likeness of a user, such as facial data and/or body data, as well as representations and/or likeness of one or more other users captured in the image or video. For example, a user may capture and image of other users having their likeness or representation, or may capture the user's likeness (e.g., a “selfie”) when intentionally photographing or videotaping the user (e.g., selecting an image recording application and requesting the application record the user's image), as well as other users that may be captured in the selfie image/video. In other embodiments, the communication device may automatically record or otherwise capture/process the images, for example, on request through or detection of a process executing on the communication device and/or by a device/server of a service provider over a network connection with the communication device. Images and/or videos may be shared using an online resource, such as a media sharing resource, social networking platform, and/or microblogging service. Such images and/or videos may be stored to the online resource and/or shared with other users, for example, through an online post by the user.

Additionally, the user may provide one or more “tags” within the online posted data that is provided to an online service and/or shared through the online service. For example, a tag may correspond to a selection in the posted data, an identifier for the user and/or another user in the posted data, a group identifier for a group of users, a word or statement preceded by a hashtag or other symbol denoting a topic or group, and/or other data that may be user to identify other users and/or groups of users (referred to herein as a “tag” or “tags”). Thus, the tags may be used to identify other users that are associated with the user and correspond to online posted data of the user. For example, a tag in a text data post to an online resource may include an identifier of the user, such as a name, account identifier (e.g., username for the account), device identifier, or other identifier used to determine an identity of the user or otherwise determine the user. Where the online post data includes an image, video, or other media content, the tag may correspond to a selection of the other user(s) in the image/video, as well as entry of an identifier for the other user(s) (e.g., selection or entry of an identifier for the other user(s)). However, in other embodiments, the online service may provide image analysis tools, such as facial recognition and/or other visual data processing techniques, which may identify the user and the other users in the image, and automatically tag the user and/or the other users, as well as provide an identifier for the user and/or other user(s) in order to detect and identify the user and/or the other user(s) in the online posted data. The online service allowing for posting of data may be accessed through one or more device applications executing on a computing device of the user, such as a mobile smart phone, tablet computer, laptop or desktop personal computer, or other device. Such device applications may allow for the user to post data to the online service, including entry of text data, uploading of an image/video, or other process for providing data to the online service.

Thus, the user may utilize one or more services providers, including online social networking services, such as FACEBOOK®, INSTAGRAM®, IMGUR®, TWITTER® or other type of media sharing, microblogging, or social networking service. Additionally, service providers may include payment providers, which may provide payment services to one or more users for use with merchants. For example, a payment provider may provide a payment platform to a user to provide payments to a merchant, for example, through electronic transaction processing using the payment platform. In this regard, the computing device of the user may further include a payment and/or transaction processing application, which may be configured to send and receive payments with other entities, such as another user and/or a merchant. The payment application may be associated with a payment provider, such as PayPal® or other online payment service, which may provide payments and other services on behalf of user, merchants, and other entities. Thus, the payment application may provide various functionalities and processes to the user and/or merchant. The user may wish to provide a payment to a user/merchant for a transaction with the user/merchant, transfer money to another family/friend, initiate and/or engage in a transaction with another entity, or perform another process. Additionally, the online payment provider may provide payment accounts and digital wallet services, which may provide accounts to send, store, and receive money, process financial instruments, and/or provide transaction histories. The online payment provider may offer further services, such as extension of credit, credit history review, account establishment and maintenance, and other financial and personal services.

Merchants may similarly use service providers, including the payment provider, to receive payments from users. Merchants (e.g., a seller or payment receiver, such as a business, fundraiser, healthcare provider, landlord, etc.) may correspond to any person or entity selling goods and/or services (referred to herein as an “item” or “items”) to other users/entities, such as buyers (e.g., a payer or payment sender, including a customer, donator, patient, renter, or other party). Thus, the merchant may engage in transactions with multiple users in one transaction, where the payment provider may further process payments for items purchased by multiple users in the single transaction. In various embodiments, the merchant may also utilize online social networking services, where a user may check-in with the merchant and/or identify the merchant within online posted data provided to the online service. However, the merchant may also be tagged as a location within online posted data through a geo-location of the merchant (e.g., GPS coordinated determined through a GPS locator of a user's computing device), an address of the merchant, a name of the merchant, and/or other identifier for the merchant.

Thus, a payment application may therefore provide one or more processes and features for use of the financial services provided by the online payment provider. The user of a computing device may utilize the payment application and/or another application executing on the computing device through various input devices of the computing device, including a keyboard, mouse, microphone, touchscreen, and/or other device capable of receiving input from the user. For example, a user may utilize the payment application to send and/or receive payments between the user and another user/merchant, including processing a transaction to provide a payment to a merchant for a transaction, where the transaction may include additional users as participants. Such transaction may correspond to a split transaction or a shared transaction, where the transaction includes multiple buyers or purchasers participating in the transaction to purchase one or more items. Thus, multiple users may be involved in a single transaction with a merchant where each of the users is responsible for specific items that each of the users purchase in the transaction. For example, three friends or colleagues may go to lunch, where the three users order together and engage in a single split or shared transaction with the merchant providing lunch. In other embodiments, other groups of users may purchase together, including co-purchasers of larger transactions, investors, etc. When processing the transaction to provide a payment to the merchant, for example, using the payment service provider, one user may process the entirety of the split transaction or group bill and may provide payment in full for the transaction. Thus, the other users involved in the transaction may be required to provide reimbursement and/or other payments (e.g., interest) back to the user that provided payment in full for the transaction. In other embodiments, more than one of the users may process the transaction, where less than all of the users provide payment for the transaction (e.g., if other users split the transaction with the merchant but one or more of the users cover a specific user's purchase). In such embodiments, one or more of the users paying for the transaction may be owed by the responsible users that have not contributed their respective portions to the transaction.

In order to provide processing of the split transaction to provide reimbursement processing to the user paying for the transaction, the service provider (e.g., the payment provider) processing the split transaction processed by the user and/or the reimbursement transactions required by the other users sharing in the split transaction may be required to determine the other users in the transaction. Thus, the payment provider may utilize online posted data by the user associated with the split transaction and having tags of the other users sharing in the split transaction and owing their respective portions to the user in the reimbursement transactions. For example, the user may pay for and process the split transaction, and may also post online data, such as an image of the other user and/or a text comment about the merchant and/or other user, to another service provider (e.g., a social networking, media sharing, and/or microblogging service). The user may tag the other users through selection of the other users in a posted image, providing or selecting an identifier for the other users, and/or entering an identifier to posted text. In various embodiments, the user may also tag themselves in the online posted data.

Where the user first pays for and processes the split transaction with the merchant, the user may later post the online data to the service provider, where the user further associates the online posted data to the processed split transaction. Thus, the payment provider may link the split transaction to the online posted data based on input by the user when posting the online data, and further determine the transaction participants (e.g., the user and the other users) using the tags within the online posted data, such as the identifiers for the other users. In various embodiments, the user may post the online data through a social networking application that allows linking to the split transaction through an application and/or process of the payment provider. However, in other embodiments, the user may link the split transaction to the online posted data through another process, such as when reviewing the split transaction with the payment provider (e.g., accessing an account of the user used to process the split transaction through an application associated with the payment provider, such as a payment application or web browser, and linking the split transaction with the online posted data). Additionally, the user may post the online data prior to processing the split transaction, where the user either associates the online posted data to the split transaction during processing the split transaction (e.g., through identification and/or selection of the online posted data during checkout and payment for the split transaction using an application of the payment provider) or at a later time (e.g., when accessing an account with the payment provider through an application of the payment provider and reviewing transaction histories to link the split transaction to the online posted data). In various embodiments, where the tag only selects an image of the user, the image may be processed against known contacts of the user (e.g., social networking friends, address book contacts, stored images, etc.) using facial recognition or other image processing to determine the identity of the other users. Thus, once the payment provider determines that the user processed a split transaction using the online posted data and the tags of the other users (as well as any linking selection made by the user to link the split transaction to the online posted data), the payment provider may determine that the other users in the transaction are required to provide reimbursement to the user for their respective portions in a reimbursement transaction.

In various embodiments, the user may not directly link the split transaction to the online posted data, or may not make selections and/or provide input that links the split transaction to the online posted data. In such embodiments, the payment provider may use available information associated with the transaction and the online posted data, such as transaction information for the split transaction, metadata for the online posted data, or other available information for the transaction and/or the online posted data. In this regard, the payment provider may link the split transaction to the online posted data through one or more of a cost of the split transaction, items in the split transaction, a number of items in the split transaction, a timestamp of the split transaction, a timestamp of the online posted data, a location of the split transaction, and/or a location of the online posted data. For example, a location of the split transaction (e.g., a location for the merchant in the split transaction and/or a geo-location provided when processing the split transaction) may be matched to a location associated with the online posted data (e.g., a geo-location attached to the online posted data). Similarly, a timestamp for the transaction may be matched to a timestamp of the online posted data.

Both matching may be given a degree of variance or difference, for example, where the locations match within a certain distance and/or the timestamps are within a set time difference. Moreover, where it is determined that the cost and/or items in the transaction indicate multiple users (e.g., high cost for one user, which may be compared to an average for the user and/or the merchant, multiple items purchased where each item may correspond to a separate user, such as multiple dinners, or other item/cost information), the payment provider may request online posted data from one or more service providers that match the transaction information, such as the location and/or timestamp of the transaction. Additionally, the aforementioned processes may also be used even when the user links the split transaction to the online posted data to determine that the transaction is a split transaction shared by the user with other users and ensure that the other users are required to provide reimbursement to the user. In this regard, the payment provider may also verify that the other users are associated with the split transaction and shared in the split transaction. In this regard, the verification may be done by receiving one or more locations for the other users at the time of the transaction, such as a check-in location, transaction location, and/or detected geo-location through a device having location detection services. The other users may also be verified as a participant in the split transaction through other online posts (e.g., social networking posts, which may tag the user paying for the split transaction and/or the merchant), replies to the user's online posted data, or other information that may be retrieved or scraped from online resources. Additionally, the other users may be required to provide verification that the other users are part of the split transaction.

Thus, after determining the other users that are participants in the split transaction, the payment provider may determine a portion of the split transaction required by each participant in the transaction, including the user that processed the transaction. In various embodiments, a cost for the split transaction may be split evenly between the user and the other users, for example, requiring each of 4 users to pay $7 for a $28 bill. However, in other embodiments, the users may pay a different amount depending on the items each user purchased in the transaction. For example, one user's items may be $10 of the $28 bill, while another's may be $5. Thus, each user may be responsible for a separate amount of the split transaction. In various embodiments, the user may tag each user in the online posted data with an amount or percentage of the split transaction owed by that user, which may be used to determine each portion owed by the other users (and the user, in certain embodiments) in the reimbursement transaction. In other embodiments, the user may also upload a receipt for the split transaction or enter items purchased in the split transaction, which may be used to select items that each user in the split transaction is responsible for payment of Thus, the payment provider may perform optical character recognition on the receipt to determine items and their corresponding cost, allow the user to tag or associate each item with one or more of the other users in the split transaction, and assign costs for the split transaction appropriately. In other embodiments, the payment provider may utilize a user history and/or transaction history of each user in the split transaction to determine which items most likely belong to each user (e.g., determination of item preferences, past items purchased, etc.). Thus, the payment provider may assign costs based on the items that each user is likely to have purchased in the split transaction, or may make recommendations to the user on how to assign costs for reimbursement for the split transaction with the other users.

Once a portion owed to the user by the other users for reimbursement of payment made for the split transaction is determined, the payment provider may process one or more reimbursement transactions to the user by the other users. The payment provider may automatically process a reimbursement transaction by one of the other users to the user, for example, if the other user opts in to a service to provide automated payments based on online post tagging for a split transaction. The payment may be made from a payment account of the other user to the user, where the payment account for the other user and the user may be provided and serviced by the payment provider. In other embodiments, the payment provider may require approval from the other user, for example, by transmitting a request to approve and process the reimbursement transaction to the other user and processing the reimbursement transaction on receipt of the approval.

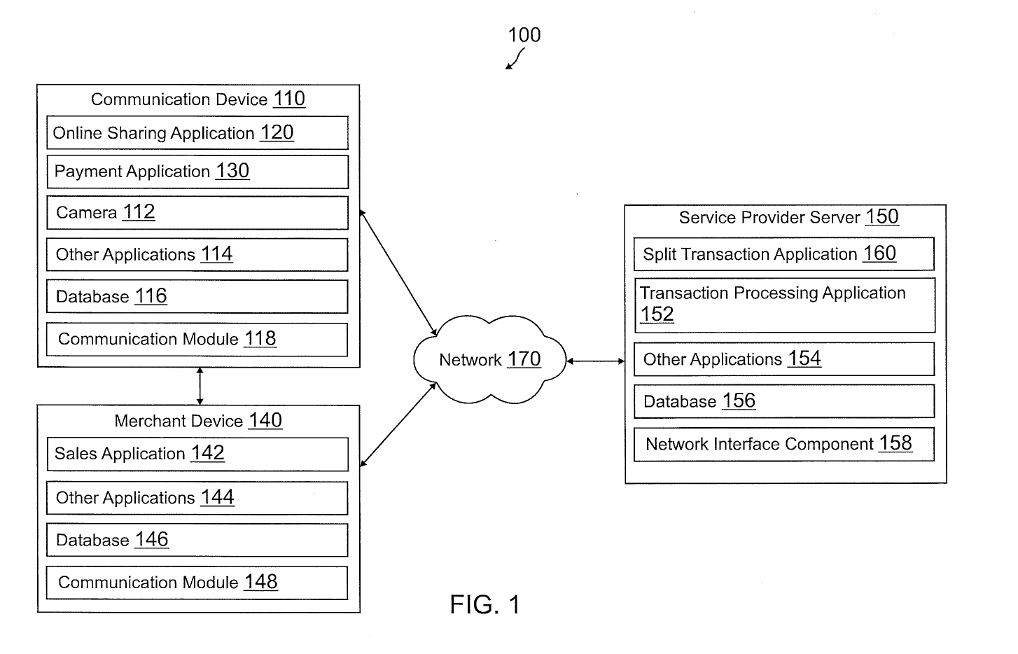

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user, a communication device 110, a merchant device 140, and a service provider server 150 in communication over a network 170. A user (not shown) may utilize communication device 110 to utilize the various features available for communication device 110, which may include processes and/or applications that may be used to process a split transaction that may be shared with other users (not shown). For example, the user may provide a payment to a merchant associated with merchant device 140 for a split transaction between the user, the other users, and the merchant, where the user and the other users purchase items in the transaction. The split transaction may be processed using service provider server 150. The user may also utilize communication device 110 to post online data, such as an image or text post to a social networking platform, where service provider server 150 may utilize the online posted data to determine that the user shared the split transaction with the other users.

Communication device 110, merchant device 140, and service provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented as a communication device that may utilize appropriate hardware and software configured for wired and/or wireless communication with merchant device 140 and/or service provider server 150. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS ®), other type of wearable computing device, implantable communication devices, and/or other types of computing devices capable of transmitting and/or receiving data, such as an IPAD® from APPLE®. Although only one communication device is shown, a plurality of communication devices may function similarly.

Communication device 110 of FIG. 1 contains an online sharing application 120, a payment application 130, a camera 112, other applications 114, a database 116, and a communication module 118. Payment application 130 and other applications 114 may correspond to executable processes, procedures, and/or applications with associated hardware. In other embodiments, communication device 110 may include additional or different modules having specialized hardware and/or software as required.

Online sharing application 120 may correspond to one or more processes to execute modules and associated specialized hardware of communication device 110 to provide an application to post online data, which may include text data and/or image/video data of a user associated with communication device 110 and/or other users sharing in a split transaction with the user. In this regard, online sharing application 120 may correspond to specialized hardware and/or software of communication device 110 to access an online resources, platform, or service that allows the user associated with communication device 110 to post data, share media content, or otherwise store and make available information to other users and entities, include service provider server 150. Thus, online sharing application 120 may correspond to a social network, a microblogging service, a media sharing service, or other online resource used to exchange information with other users and services, including messaging platforms or platforms having messaging capabilities. The user associated with online sharing application 120 may utilize an account of the user with the online resource in order to post and/or share data to the online resource, or may provide an identifier for the user when posting and/or sharing data on the online resource, such as a name, nickname or online username, device identifier, network identifier, or other type of identifier. Thus, in certain embodiments, online sharing application 120 may receive input having authentication credentials for the account and/or user, or may access the credentials stored to database 116 or other accessible storage.

Online sharing application 120 may be used by the user of communication device 110 to post online data that may include other users. In this regard, online sharing application 120 may access the online resource, where the user may input data into online sharing application 120 for uploading, posting, and/or sharing on the online resource. The input may correspond to online posted data using the online resource. In various embodiments, the user may enter the input through a keyboard, mouse, touchscreen interface, or other input device. In such embodiments, the input may correspond to text data for posting to the online resource. In further embodiments, camera 112 may be used to capture an image (or video), where the user may select the image to post to the online resource, for example, using an interface of online sharing application 120. Online sharing application 120 may then upload the image to the online resource. Thus, online sharing application 120 may access a captured image by camera 112 (or received by communication device 110 from another device) to upload to the online resource. However, in other embodiments, online sharing application 120 may utilize one or more processes to capture the image using camera 112, which may then be uploaded to the online resource.

The online posted data may include one or more tags of the user and/or other users. For example, the online posted data may include selections in an image/video of the user and other users associated with the user and involved in a split transaction with the user. The selections may be done through making selections by the user of another user's likeness or representation in the image/video, or other image/video data that identifies the other user. Additionally, the online posted data may include identifiers for the one or more other users with the user (as well as the user where the user is tagged in the online posted data). The identifiers may be used to identify the other users (and the user), for example, through a name, account, username, etc. The online posted data may include a timestamp, location (e.g., entered by the user or provided using a GPS locator of communication device 110), and/or other metadata associated with posting the online data, which may be used by service provider server 140 to associate the split transaction with the online posted data. The tags within the online posted data may further include additional information for processing reimbursement transactions required by the other users for their portion of the split transaction, such as an amount owed by each of the other users and/or percentage owed by each of the other users, which may be user specific. In various embodiments, the online posted data may further include a receipt or other entry of information on items and/or costs associated with the split transaction, including tax, tip, etc. Such information may include items purchased by each user and/or costs associated with each user. In various embodiments, online sharing application 120 may further be used to provide data linking the online posted data to a split transaction, for example, through entry of data to online sharing application 120 and/or selection of one or more menu options. Such link may be used by service provider server 150 to determine the other users sharing the split transaction, as discussed herein. However, in other embodiments, the user may link the online posted data to the split transaction through payment application 130.

Payment application 130 may correspond to one or more processes to execute modules and associated devices of communication device 110 to process a split transaction by the user associated with communication device 110 with a merchant, where the split transaction includes other users that are also transaction participants (e.g., the other users also have purchased items in the split transaction and are responsible for part of the cost of the split transaction). Thus, in various embodiments, payment application 130 may be utilized by the user of communication device 110 to provide an interface to permit the user associated with communication device 110 to select payment options and provide payment for items, for example, to a merchant through merchant device 140 using service provider server 150. Payment application 130 may be implemented with a user interface enabling the user to enter payment options, select and provide payment options on checkout/payment of one or more items with a merchant, and complete a split transaction for the item(s) through processing a payment request for the item(s) with service provider server 150. Payment application 130 may also be used to establish a user account, such as a payment account, with service provider server 150 to provide payments through the payment account. Payment application 130 may be used to link the payment account to the online resource associated with online sharing application 120 and/or account of the user with the online resource, for example, for use during processing split transactions and/or linking split transactions to online posted data having identifiers for other users sharing in the split transactions. Moreover, payment application 130 may be used to opt-in to automatic credit, debit, and/or transaction processing of reimbursement payments to users in split transactions.

In this regard, payment application 130 may initiate, engage in, and/or receive a split transaction, where the split transaction includes one or more items for purchase by the user and the other users from a merchant. Payment application 130 may be used to process the split transaction with service provider server 140 to provide a payment to merchant device 140 for the entirety of the split transaction. Thus, the other user may be required to provide reimbursement to the user of communication device 110 for their respective portion of the split transaction. The payment request may be processed using a payment account for the user. For example and as discussed herein, service provider server 150 may be used to provide payment to the merchant associated with merchant device 140. Payment application 130 may therefore be used to provide payment information for use in processing the payment. Payment application 130 may utilize user financial information, such as a credit card, bank account, or other financial account, as a payment instrument when providing payment information for use in a payment request generated through a social networking comment. Additionally, payment application 130 may utilize a user account with payment provider, such as service provider server 150, as the payment instrument. Payment application 130 may be utilized to view the results of the transaction and/or for viewing and storage of a transaction history, such as a receipt. The user may associate online posted data by online sharing application 120 with the split transaction, for example, during transaction processing through one or more interfaces or menu options, or by providing input linking the split transaction to the online posted data. Additionally the user may upload the receipt and/or provide information with the receipt to service provider server 150 for use in determining a portion owed by each user in the split transaction. In other embodiments, the user may designate the portion owed by each user through input to payment application 130. In various embodiments, payment application 130 may correspond to a general browser application configured to retrieve, present, and communicate information over the Internet (e.g., utilize resources on the Internet) or a private network. In other embodiments, payment application 130 may include a dedicated application of service provider server 140, which may be configured to purchase items through input provided to payment application 130.

One or more of the aforementioned features and/or processes of online sharing application 120 may be included within payment application 130 or vice versa, for example, to provide their respective features within one application and/or application interface.

Camera 112 corresponds to an optical device of communication device 110 enabling a user associated with communication device 110 to capture or record images, including still and/or video images. Camera 112 may correspond to a digital camera on communication device 110, or may more generally correspond to any device capable of capturing or recording an image, video, or other digital media with the capability to capture the likeness or representation of one or more users. Camera 112 may include various features, such as zoom, flash, focus correction, shutter speed controls, or other various features usable to capture one or more images of the user and/or other users involved in a split transaction. Camera 112 may further display a preview and/or captured image to the user through another device of communication device 110, such as a viewfinder, screen (e.g., mobile phone screen), or other display. Camera 112 may interface with one or more applications of communication device 110 for the user of communication device 110 and/or other users sharing in the split transaction, where the other users are required to provide reimbursement to the user of communication device 110 for their respective portion owed for the cost of the split transaction.

In various embodiments, communication device 110 includes other applications 114 as may be desired in particular embodiments to provide features to communication device 110, for example, those applications, processes, and/or features that may not be provided by one or more of online sharing application 120 and/or payment application 130. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications 114 may include social networking applications, media viewing, and/or merchant applications. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as display devices capable of displaying information to users and other output devices.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment application 130 and/or other applications 114, identifiers associated with hardware of communication device 110, or other appropriate identifiers, such as identifiers used for payment/user/device authentication or identification, which may be communicated as identifying communication device 110 to service provider server 150. Database 116 may include one or more images of a user associated with communication device 110, which may further capture likenesses and/or representations of other users sharing in a split transaction with the user. Additionally, received transaction information for one or more split transactions, as well as transaction processing information may be stored to database 116.

Communication device 110 includes at least one communication module 118 adapted to communicate with merchant device 140 and/or service provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Merchant device 140 may be maintained, for example, by a merchant that provides sales to users through communication device 110 and/or service provider server 150, which may include sale of items for more than one user in a split transaction between the users. In this regard, merchant device 140 may correspond to a device having processing applications, which may be configured to interact with communication device 110 to engage in split transactions. Merchant device 140 may further interface with service provider server 150 for transaction processing of the split transactions. Merchant device 140 may be implemented using any appropriate hardware and software configured for wired and/or wireless communication with communication device 110 and/or communication device 130. For example, in one embodiment, merchant device 140 may be implemented as a single or networked personal computer (PC), a smart phone, laptop computer, wearable computing device, and/or other types of computing devices at a merchant location capable of transmitting and/or receiving data. Although only one merchant device is shown, a plurality of merchant devices may function similarly.

Merchant device 140 of FIG. 1 contains a sales application 142, other applications 144, a database 146, and a communication module 148. Sales application 142 and other applications 144 may correspond to processes, procedures, and/or applications executable by a hardware processor, for example, a software program. In other embodiments, merchant device 140 may include additional or different modules having specialized hardware and/or software as required.

Sales application 142 may correspond to one or more processes to execute modules and associated specialized hardware of merchant device 140 that provide sales, checkout, and payment processes for a transaction to purchase one or more items for sale from a user, such as a merchant or seller, corresponding to merchant device 140. In this regard, sales application 142 may correspond to specialized hardware and/or software of merchant device 140 to provide a convenient interface to permit a seller to enter, view, and/or edit items and/or services for purchase by the buyer associated with communication device 110. For example, sales application 142 may be implemented as an application having a user interface enabling the seller to enter item information and request payment for a transaction on checkout/payment of one or more items/services. In certain embodiments, sales application 142 may correspond more generally to a web browser configured to provide information over the Internet, for example, by hosting a website or online marketplace corresponding to the merchant and/or communicating information to another online marketplace utilized by the merchant or seller. Thus, sales application 142 may provide item sales through an online marketplace using the website of the merchant or another service provider. Thus, the user associated with communication device 110 may initiate a split transaction using sales application 142, where transaction processing may occur through interfacing between communication device 110 and merchant device 140. Thus, item sales and/or transaction information may be communicated to communication device 110, where the user associated with communication device 110 may view and interact with the information, for example, to approve or decline transaction processing.

Once a payment amount is determined for a split transaction for items to be purchased by users, such as the user associated with communication device 110 and other users, sales application 142 may request payment from the user associated with communication device 110 for transaction processing. Payment may be provided through a payment instrument. Sales application 142 may provide additional sales incentives and available payment processes, such as a payment plan, extendable credit, or other incentive (e.g., rebates, discounts, etc.). Payment information may be communicated to merchant device 140 by communication device 110, which may be used with the split transaction and transaction information for approval. Sales application 142 may then receive the results of the transaction processing, and complete the split transaction with the user, for example, by providing the user and the other the items for the split transaction or declining the split transaction where the user is not authenticated or the split transaction is not authorized (e.g., insufficient funds, rejection of the transaction based on risk analysis, etc.). Sales application 142 may receive a payment notification from service provider server 150, including the payment value. A transaction history or receipt may then be generated by sales application 142 and provided to one or more of communication device 110 and/or service provider server 150. The transaction history may further include additional information for use in apportioning costs in the split transaction, such as items purchased by each user in the split transaction.

Merchant device 140 includes other applications 144 as may be desired in particular embodiments to provide features to merchant device 140. For example, other applications 144 may include security applications for implementing client-side security features, programmatic client applications for interfacing with appropriate application programming interfaces (APIs) over network 180, or other types of applications. Other applications 144 may also include email, texting, voice and IM applications that allow a user to send and receive emails, calls, texts, and other notifications through network 180. In various embodiments, other applications 144 may include financial applications, such as banking, online payments, money transfer, or other applications associated with communication device 130. Other applications 144 may contain software programs, executable by a processor, including a graphical user interface (GUI) configured to provide an interface to the user.

Merchant device 140 may further include database 146 which may include, for example, identifiers such as operating system registry entries, cookies associated with sales application 142 and/or other applications 144, identifiers associated with hardware of merchant device 140, or other appropriate identifiers, such as identifiers used for payment/user/device authentication or identification. Identifiers in database 146 may be used by a payment/credit provider to associate merchant device 140 with a particular account maintained by the payment/credit provider. Database 146 may further include transaction information and/or results, including received payment information.

Merchant device 140 includes at least one communication module 148 adapted to communicate with communication device 110 and/or service provider server 150. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 150 may be maintained, for example, by an online service provider, which may provide split transaction determination and processing services, as well as additional transaction and payment services, to one or more users. In this regard, service provider server 150 includes one or more processing applications which may be configured to interact with communication device 110, merchant device 140, and/or another device/server to facilitate connecting users having a shared interest. In one example, service provider server 150 may be provided by PAYPAL®, Inc. of San Jose, Calif., USA. However, in other embodiments, service provider server 150 may be maintained by or include another type of service provider, which may provide the aforementioned services to a plurality of users.

Service provider server 150 of FIG. 1 includes a split transaction application 160, a transaction processing application 152, other applications 154, a database 156, and a network interface component 158. Transaction processing application 152 and other applications 154 may correspond to executable processes, procedures, and/or applications with associated hardware. In other embodiments, service provider server 150 may include additional or different modules having specialized hardware and/or software as required.

Split transaction application 160 may correspond to one or more processes to execute software modules and associated specialized hardware of service provider server 150 to receive at least a split transaction processed by a user, where the user requires reimbursement from the other users in the split transaction, and determine the other users in the split transaction using online posted data by the user processing the split transaction. In this regard, transaction processing application 152 may correspond to specialized hardware and/or software to receive information for a split transaction processed by a user and/or online posted data by the user to an online resource (e.g., a social networking platform, media sharing service, microblogging service, etc.). For example, split transaction application 160 may receive, from merchant device 140 and/or transaction processing application 152, data for a processed split transaction having the user and other additional users as transaction participants in purchasing items from the merchant associated with merchant device 140. The data for the split transaction may include transaction information, such as a cost of the split transaction, items in the split transaction, tax, tip, and/or other transaction information. In various embodiments, the user and/or the merchant may include user information for the user and/or the other users that allows identification of the user and/or the other users, as well as items purchased by each user in the split transactions. Moreover, the data for the split transaction may include additional linking information that links the split transaction to online posted data. Thus, split transaction application 160 may request and/or retrieve the online posted data based on linking information, such as an identifier for the online posted data that allows lookup, determination, and/or retrieval of the online posted data from the online resource having the online posted data. In various embodiments, split transaction application 160 may receive the online post data first based on input and/or selection by the user that links the online data to a split transaction. In such embodiments, the user may request that the online posted data is transmitted to split transaction application 160. Thus, split transaction application 160 may utilize the online posted data and linking information to a split transaction to retrieve the split transaction.

Once transaction information for the split transaction and online posted data are received with linking information for the split transaction and the online posted data, split transaction application 160 may utilize tags of the other users (and the user, if additionally tagged in the online posted data) to determine all of the transaction participants in the split transaction. For example, the tags may include identifiers entered with and/or to text, image, and/or video in the online posted data. The identifiers may be used to determine or identify the other users, for example, through a name, account identifier (e.g., for a payment account and/or account with the online resource), contact information (e.g., email, phone number, etc.), or other information necessary to determine an identity of each of the other users. The identifiers may also be used to process a payment to the user from the other users, such as a payment in a reimbursement transaction for the other users' respective shares of the split transaction. Where the user associated with communication device 110 is not tagged, split transaction application 160 may determine that the user is associated with the split transaction and has processed the split transaction using a receipt for the split transaction or transaction history for the user, and/or based on the user posting the online posted data.

In various embodiments, the tags may also correspond to selections in an image or video, such as a selection of a facial or body representation of each of the other users in the image/video. Where an identifier is not provided in an image and/or video, the other users may be identified by split transaction application 160 through facial recognition and/or other image or video processing technique to determine an identity of each of the other users. Moreover, if an identifier is not provided in a text post, the other users may be identified by split transaction application 160 through analysis of the text, such as names in the text, as well as lookup of the same or similar names associated with the user (e.g., using a contact list application, social network friends list, known past associates of the user, etc.). Split transaction application 160 may be required to determine that the split transaction is shared by other users where the user does not designate the split transaction as shared by the other user. Thus, the other users in the split transaction may be determined by split transaction application 160 using locations of the other users determined through a check-in (e.g., with the merchant, social network, service provider server 150, etc.), a geo-location determined through a GPS locator or other location detection service, a transaction history, or other available data. The locations may include timestamps, which may be used to match the locations of the other users to the location of the split transaction. Split transaction application 160 may also determine that the split transaction is shared by the other users using online posted data of the other users, items and/or cost of the split transaction, and/or past data of the other users (e.g., past purchases, associations with the user, etc.)

Additionally, the aforementioned location matching may be used by split transaction application 160 to verify that each of the other users were transaction participants in the transaction. In this regard, a location of the other users at a time matching the split transaction's location and/or location associated with the online posted data may be determined through a transaction history, geo-location detection device of the other users (e.g., GPS locator of a communication device), check-in with an online resource, and/or online posted data of the other users. The location(s) of the other users may be matched by split transaction application 160 to the split transaction's location and/or location associated with the online posted data at the same or similar times to verify that each of the other users were co-located with the user to be able to share in the split transaction. However, in embodiments where the other users may still share in the split transaction but be located elsewhere (e.g., where the user picks up an order of food for the other users), such verification may be unnecessary and/or overcome by additional input verifying the transaction by the user and/or the other users.

Split transaction application 160 may also be used to determine a portion owed by each of the other users to the user. In various embodiments, the portion may correspond to an even split between each of the user and the other users. However, where each user in the split transaction is apportioned a separate share of the split transaction that the user is responsible for, split transaction application 160 may determine a different amount for each of the users. For example, the user may provide input to the split transaction corresponding to an amount of percentage that the user and each of the other users owe for the split transaction, which may be used to determine the portion for each of the other users' reimbursement owed to the user. In other embodiments, split transaction application 160 may utilize a receipt for the split transaction to apportion costs for the portion owed by each user. The receipt may be used with transaction histories for each user to determine the item(s) that each of the users purchased, which may be confirmed with the users. Once a portion for each of the other users is determined, split transaction application 160 may generate one or more reimbursement transactions for the portion owed by each of the other users to the user, which may be processed by transaction processing application 152

Transaction processing application 152 may correspond to one or more processes to execute software modules and associated specialized hardware of service provider server 150 to provide transaction processing services to users, for example though a payment account and/or payment instruments, which may include payment during transaction processing of a split transaction and/or reimbursement transaction. In this regard, transaction processing application 152 may correspond to specialized hardware and/or software to provide payment services and payment accounts, including digital wallets storing payment instruments. The transaction processing services may allow for a payment by a user to a merchant for a split transaction through a payment instrument, including a credit/debit card, banking account, payment account with service provider server 150, and/or other financial instrument. The split transaction may include other users sharing in the split transaction. Thus, the transaction processing services may further include services to process reimbursement transactions determined by split transaction application 160, where the reimbursement transactions provide a payment to the user by the other users for a portion owed by the other users to the user.

In order to establish a payment account for a user to send and receive payments, transaction processing application 152 may receive information requesting establishment of the payment account. The information may include user personal and/or financial information. Additionally the information may include a login, account name, password, PIN, or other account creation information. The user may provide a name, address, social security number, or other personal information necessary to establish the account and/or effectuate payments through the account. Transaction processing application 152 may further allow the user to service and maintain the payment account, for example, by adding and removing payment instruments. Transaction processing application 152 may be used to process a split transaction between a user paying for the split transaction and a merchant. In order to perform transaction processing of the split transaction and/or payments, transaction processing application 152 may debit an account of the user and provide the payment to an account of the merchant. After processing the split transaction, transaction processing application 152 may further be used to process reimbursement transactions between the other users shared the split transaction and the user. Thus, when processing the reimbursement transactions, transaction processing application 152 may debit accounts of the other users and provide reimbursement payments to the account of the user. In various embodiments, the reimbursement transactions may be processed with input by the other users, for example, if the other users opt in to automatic debits for split transactions. However, in other embodiments, transaction processing application 152 may require approval by the other users for transaction processing. Transaction processing application 152 may also be used to provide transaction histories for processed transactions.

In various embodiments, service provider server 150 includes other applications 154 as may be desired in particular embodiments to provide features to service provider server 150. For example, other applications 154 may include security applications for implementing server-side security features, programmatic client applications for interfacing with appropriate application programming interfaces (APIs) over network 170, or other types of applications. Other applications 154 may contain software programs, executable by a processor, including a graphical user interface (GUI), configured to provide an interface to the user when accessing service provider server 150, where the user or other users may interact with the GUI to more easily view and communicate information. In various embodiments, other applications 154 may include connection and/or communication applications, which may be utilized to communicate information to over network 170.

Additionally, service provider server 150 includes database 156. As previously discussed, a user may establish one or more digital wallets and/or payment accounts with service provider server 150. Digital wallets and/or payment accounts in database 156 may include user information, such as name, address, birth date, payment instruments/funding sources, additional user financial information, user preferences, and/or other desired user data. Users may link to their respective digital wallets and/or payment accounts through an account, user, and/or device identifier. Thus, when an identifier is transmitted to service provider server 150, e.g., from communication device 110, one or more digital wallets and/or payment accounts belonging to the users may be found. Database 156 may also store received transaction information for split transactions and/or reimbursement transactions, as well as online posted data linked to split transactions.

In various embodiments, service provider server 150 includes at least one network interface component 158 adapted to communicate communication device 110 and/or merchant device 140 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

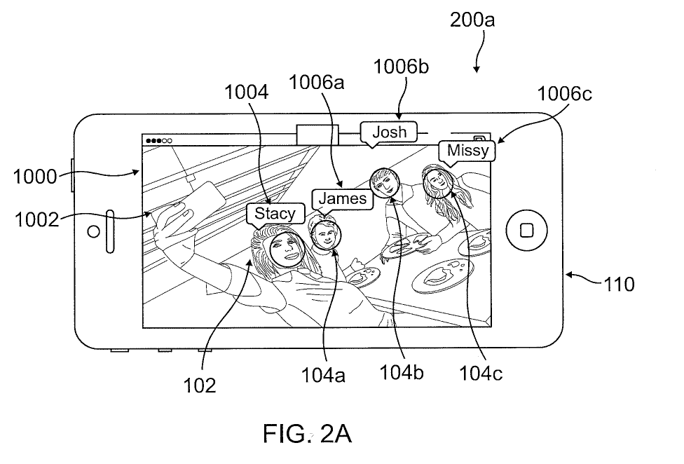

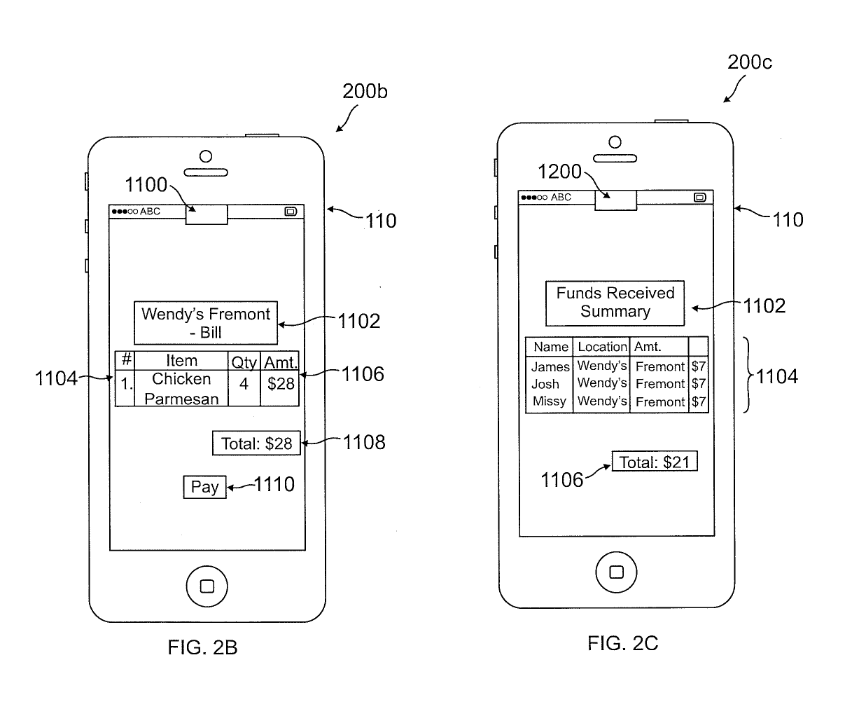

FIG. 2A is an exemplary graphical user interface of an application capturing an image of multiple users involved in a split transaction, according to an embodiment. Environment 200a includes communication device 110 corresponding generally to the described features, processes, and components of communication device 110 in environment 100 of FIG. 1. In this regard, a user 102 utilizing communication device 110 may view an interface 1000 on communication device 110, where interface 1000 provides captured data for posting to an online resource, for example, those features and processes provided by one or more of online sharing application 120 and/or payment application 130 of communication device 110 in environment 100 of FIG. 1.

In this regard, user 102 may utilize communication device 110 to capture an image 1002 of user 102 with other users during an event where user 102 may process a split transaction. For example, interface 1000 displays image 1002 having user 102 with a user 104a, a user 104b, and a user 104c. Once image 1002 is captured, user 102 may then tag user 102 in image 1002 with a tag 1004, where tag 1004 may identify user 102 in image 1002. Additionally, user 102 tags user 104a with a tag 1006a, user 104b with a tag 1006b, and user 104c with a tag 1006c. Thus, user 102 tags all users in image 1002 with tag 1004 and tags 1006a-c in order to identify all users at the event. Additionally, image 1002 with tag 1004 and tags 1006a-c may be used to determine all the transaction participants in the split transaction processed by user 102. For example, tags 1006a-c may be used to identify users 104a-c as sharing in the split transaction using image 1002. Once tagged, image 1002 may be uploaded to an online resource for sharing, such as a social networking platform.

FIG. 2B is an exemplary graphical user interface of an application processing a split transaction between a group of users, according to an embodiment. Environment 200b includes a communication device 110 corresponding generally to the described features, processes, and components of communication device 110 in environment 100 of FIG. 1. In this regard, a user utilizing communication device 110 may view an interface 1100 on communication device 110, where interface 1100 displays information for a split transaction for processing by an application, for example, using features and processes provided by payment application 130 of communication device 110 in environment 100 of FIG. 1.

For example, interface 1100 displays a split transaction 1102 processed by user 102 in environment 200a of FIG. 2A. Split transaction 1102 may further be shared by users 104a-c in environment 200a of FIG. 2A. Thus, split transaction 1102 includes items 1104 purchased by user 102 and users 104a-c from a merchant, where user 102 has processed a payment for split transaction 1102. For example, amount 1106 may be totaled for split transaction 1102 and a transaction cost 1108 may be paid by user 102 on selection of payment process 1110 to the merchant, where users 104a-c are required to provide reimbursement to user 102. Thus, a service provider may further provide processes to determine users 104a-c shared in split transaction 1102 and are required to process reimbursement transactions for their items of items 1104 having amounts of amounts 1106.

FIG. 2C is an exemplary graphical user interface of an application displaying reimbursement transactions to a user that processed a split transaction from the other users in a split transaction, according to an embodiment. Environment 200c includes a communication device 110 corresponding generally to the described features, processes, and components of communication device 110 in environment 100 of FIG. 1. In this regard, a user utilizing communication device 110 may view an interface 1200 on communication device 110, where interface 1100 displays information for reimbursement transactions processed by a service provider, for example, using features and processes provided by payment application 130 of communication device 110 in environment 100 of FIG. 1.

In this regard, interface 1200 displays a reimbursement transaction processed to provide reimbursement to user 102a in environment 200a of FIG. 2A associated with communication device 110 based on a split transaction processed by the user to provide a payment that includes payment for items users 104a-c in environment 200a of FIG. 2A purchases and/or possessed. For example, interface 1200 displays a summary 1102 of received funds, for example, reimbursement payment amounts for a portion of split transaction 1102 in environment 200b of FIG. 2B owed by users 104a-c to user 102. Thus, reimbursement transactions 1104 are shown, which may be paid by users 104a-c to user 102. Additionally, user 102 may confirm a total reimbursement 1106 for reimbursement transactions 1104 that is received in a payment account for user 102 based on processing reimbursements for split transaction 1102.

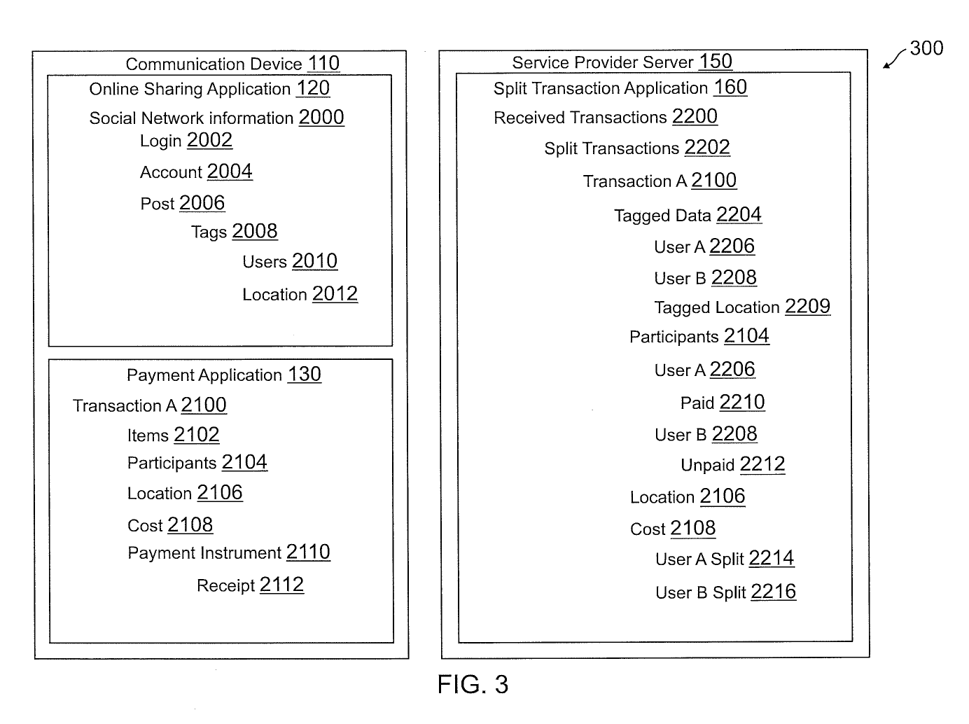

FIG. 3 is an exemplary system environment showing a communication device interacting with a service provider for digital image tagging for split transaction processing, according to an embodiment. FIG. 3 includes communication device 110 and service provider server 150 both discussed in reference to environment 100 of FIG. 1.

Communication device 110 executes online sharing application 120 corresponding generally to the specialized hardware and/or software modules and processes described in reference to FIG. 1. In this regard, online sharing application 120 may be utilized to post online data to an online resource, where the online data includes information and/or tags used to identify other users sharing a split transaction that a user that processed using communication device 110 and service provider server 150. For example, online sharing application 120 includes social networking information, which may correspond to information posted to a social network by the user associated with communication device 110. Social networking information 2000 includes a login 2002 for a social network and/or social network account, such as an account 2004. Using account 2004, the user may provide post 2006, which includes tags 2008 of users 2010 and location 2012. Thus, users 2010 may be involved in the split transaction at location 2012.

Communication device 110 executes payment application 130 corresponding generally to the specialized hardware and/or software modules and processes described in reference to FIG. 1. In this regard, payment application 130 may execute a process to provide payment for a split transaction, where the split transaction is processed by the user of communication device 110 to provide the payment, which includes payment for the other users sharing in the split transaction. For example, the split transaction may correspond to transaction A 2100, which may be processed using service provider server 150. Transaction A 2100 may include items 2102 for purchase by the users in the split transaction. In various embodiments, transaction A 2100 may include information for participants 2104, however, in other embodiments, participants 2104 may be determined by service provider server 150. Additionally, transaction A 2100 includes a location 2106 and a cost 2108. Cost 2108 may be processed to provide a payment for costs 2108 using a payment instrument 2110. Additionally, payment application 130 may include information for a receipt 2112.

Service provider server 150 executes split transaction application 160 corresponding generally to the specialized hardware and/or software modules and processes described in reference to FIG. 1. In this regard, split transaction application 160 may receive information for a split transaction and online posted data linked to the split transaction to determine transaction participants in the split transaction. Thus, split transaction application 160 includes received transactions 2200, which includes split transactions 2202. Split transactions 2202 include transaction A 2100 from payment application 130. Split transaction application 160 may process transaction A 2100 using tagged data 2204, such as online posted data using online sharing application (e.g., post 2006). Tagged data 2204 includes a tag for user A 2206 and user B 2208. Moreover, tagged data 2204 further includes tagged location 2209 for tagged data 2204. Using tagged data 2004, participants 2104 may be determined as user A 2206 for transaction A 2100 and user B 2208 for transaction A 2100. Split transaction application 160 may determine used requiring reimbursement for transaction A 2100. For example, user A 2206 is associated with a paid status 2210, where user A 2006 may have processed split transaction 2100. In contrast, user B 2208 is associated with an unpaid status 2212, where user B 2208 is required to process a reimbursement transaction. Location 2108 may be used to determine participants 2104. Additionally, cost 2108 may be split to determine user A split 2214 and user B split 2216, where user B split 2216 may be used to determine a reimbursement transaction for user B 2208 based on unpaid status 2212.

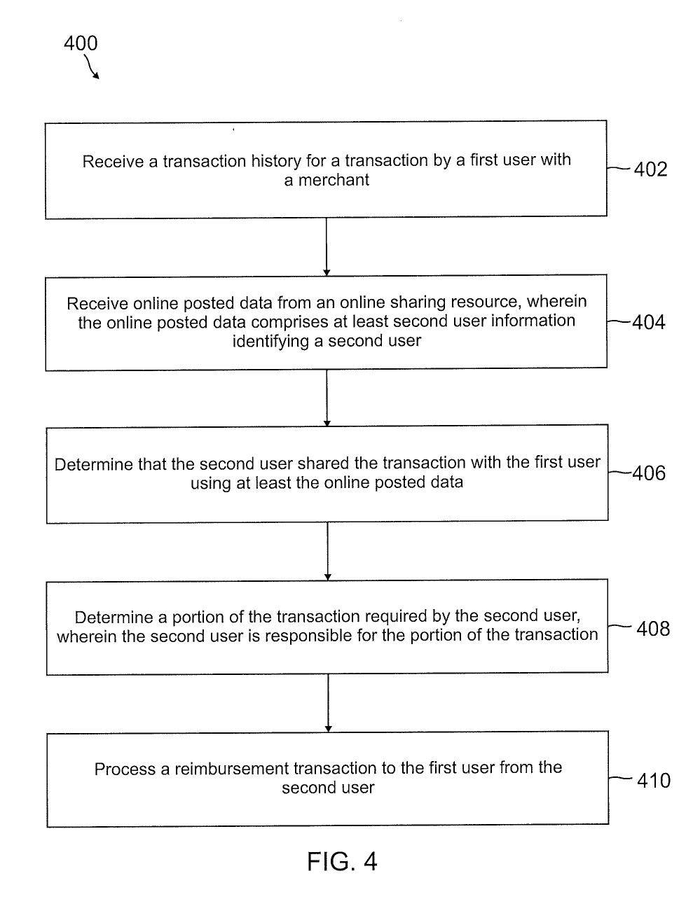

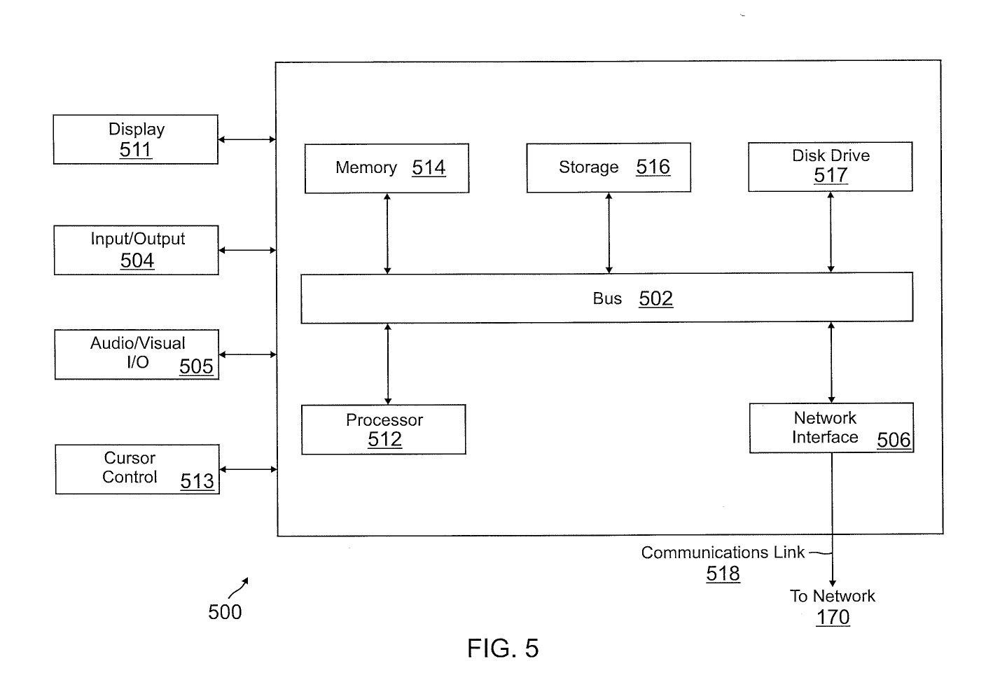

FIG. 4 is a flowchart of an exemplary process for digital image tagging for split transaction processing, according to an embodiment. Note that one or more steps, processes, and methods described herein may be omitted, performed in a different sequence, or combined as desired or appropriate.

At step 402, a transaction history for a transaction by a first user with a merchant is received. The transaction history may correspond to a split transaction by a first user sharing the transaction with at least a second user. In various embodiments, a mobile application executed by a computing device, such as a mobile smart phone, processes the transaction with the service provider. The mobile application may utilize a payment instrument, such as a transaction processing account with a service provider associated with the mobile application, to process the transaction.

Online posted data is received from an online sharing resource, wherein the online posted data comprises at least second user information identifying a second user, at step 404. The online posted data may comprise a digital image, where digital image further comprises a first tag of the second user image by the first user with an identifier of the second user. In various embodiments, in response to the determining that the first user processed the split transaction, the digital image may be requested from the image sharing resource based on at least one of a timestamp for the split transaction or a location of the split transaction. For example, transaction information for the split transaction may be received, and it may be determined that the first user processed the split transaction using the transaction information, wherein the digital image is received with the transaction information. In other embodiments, the online posted data comprise one of an image, a video, a social network post with a tagged location in the social networking post, or microblogging post with the tagged location in the microblogging post.

At step 406, it is determined that the second user shared the transaction with the first user using at least the online posted data. Where the online posted data comprises a digital image, the digital image as the online posted data may further comprise a first user image of the first user and a second tag of the first user image, wherein the determining that at least the second user shared the split transaction with the first user further uses the first tag and the second tag. The first tag and the second tag may comprise selections made in the digital image using a social networking application associated with the image sharing resource. Determining that at least the second user shared the split transaction with the first user may further use a location associated with the split transaction and the digital image. Additionally, timestamps of the split transaction and the digital image may also be used to determine that the second user shared in the split transaction, as well as linking or identifying the digital image in the split transaction or vice versa. Moreover, the split transaction may be identified as shared based on items in the split transaction and/or cost of the split transaction.

At step 408, a portion of the transaction required by the second user is determined, wherein the second user is responsible for the portion of the transaction. The first tag of the second user may further comprise a percentage amount owed by the second user for the payment, wherein the portion is determined based on the percentage amount owed. A reimbursement transaction to the first user from the second user is processed, at step 410. In various embodiments, approval for a transfer of the amount for the portion may be requested from the second user, and confirmation of the approval for the transfer from the second user may be received. However, in other embodiments, the transfer for the reimbursement transaction may be performed automatically. Moreover, the first user may be notified in an account of the first user or through a transaction history of the reimbursement transaction.

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the system to perform operations comprising:
determining that a first user processed a split transaction comprising a payment made by the first user to a merchant;
receiving a digital image from an image sharing resource, wherein the digital image comprises an image of a second user;
determining that the second user shared the split transaction with the first user using at least the digital image;
determining a portion of the payment for the split transaction required by the second user;
determining a payment account for the second user; and
transferring an amount for the portion from the payment account of the second user to a payment account of the first user.

2. The service provider system of claim 1, wherein prior to the transferring the amount for the portion, the operations further comprise:
requesting approval for a transfer of the amount for the portion from the second user; and
receiving confirmation of the approval for the transfer from the second user.

3. The service provider system of claim 1, wherein the digital image further comprises a first tag of the image of the second user by the first user with an identifier of the second user.

4. The service provider system of claim 3, wherein the first tag further comprises a percentage amount owed by the second user for the payment, and wherein the portion is determined based on the percentage amount owed.

5. The service provider system of claim 3, wherein the digital image further comprises an image of the first user and a second tag of the image of the first, wherein the determining that at least the second user shared the split transaction with the first user further uses the first tag and the second tag.

6. The service provider system of claim 5, wherein the first tag and the second tag comprise selections made in the digital image using a social networking application associated with the image sharing resource.

7. The service provider system of claim 1, wherein the operations further comprise
in response to the determining that the first user processed the split transaction, requesting the digital image from the image sharing resource based on at least one of a timestamp for the split transaction or a location of the split transaction.

8. The service provider system of claim 1, wherein prior to the determining that the first user processed the split transaction, the operations further comprise:
receiving transaction information for the split transaction,
wherein the determining that the first user processed the split transaction uses the transaction information, and wherein the digital image is received with the transaction information.

9. The service provider system of claim 1, wherein the determining that at least the second user shared the split transaction with the first user further uses a location associated with the split transaction and the digital image.

10. The service provider system of claim 1, wherein the determining that at least the second user shared the split transaction with the first user further uses a first timestamp of the split transaction and a second timestamp of the digital image.

11. The service provider system of claim 1, wherein the determining that at least the second user shared the split transaction with the first user further uses at least one of a first identification of the digital image in the split transaction or a second identification of the split transaction associated with the digital image.

12. A method comprising:
receiving a transaction history for a transaction by a first user with a merchant;
receiving online posted data from an online sharing resource, wherein the online posted data comprises at least user information identifying a second user;
determining that the second user shared the transaction with the first user using at least the online posted data;
determining a portion of the transaction corresponding to the second user, wherein the second user is responsible for the portion of the transaction; and
processing a reimbursement transaction to the first user from the second user.

13. The method of claim 12, further comprising:
requesting the online posted data based on one of receiving an indication that the first user and the second user shared the transaction, determining that the first user and the second user shared the transaction based on a total cost of the transaction, or determining that the first user and the second user shared the transaction based on items in the transaction,
wherein the online posted data is received in response to the requesting the online posted data.

14. The method of claim 12, further comprising:
associating the online posted data with the transaction based on a first location for the transaction and a second location tagged by the online posted data,
wherein the online posted data is received in response to the associating the online posted data with the transaction.

15. The method of claim 12, wherein the online posted data comprises one of an image, a video, a social network post with a tagged location in the social networking post, or a microblogging post with the tagged location in the microblogging post.

16. A computing device system comprising:
a non-transitory memory; and
one or more hardware processors coupled to the non-transitory memory and configured to read instructions from the non-transitory memory to cause the system to perform operations comprising:
accessing, by the computing device system for a first user, an online social networking resource associated with the first user;
communicating a post to the online social networking resource to share on an online social networking platform corresponding to the online social networking resource, wherein the post identifies a second user associated with the first user;
processing, with a service provider, a transaction for the first user and the second user with a merchant using a payment instrument of the first user, wherein the first user and the second user share the transaction; and
receiving, from the service provider, an indication that the second user processed a reimbursement transaction for a portion of the transaction required by the second user.

17. The computing device system of claim 16, wherein a mobile application executed by the computing device system processes the transaction with the service provider.

18. The computing device system of claim 17, wherein the payment instrument comprises a transaction processing account with the service provider associated with the mobile application.

19. The computing device system of claim 16, wherein the post comprises a tag of the second user, and wherein the tag is associated with an identifier for the second user.

20. The computing device system of claim 16, wherein the indication comprises one of an account notification in an account of the user used to processes the transaction or a transaction history for the reimbursement transaction communicated to the computing device system.
